(19) United States
(12) Patent Application Publication
(10) Pub. No.: US 2023/0142249 A1
(43) Pub. Date: May 11, 2023

(54) MIXING NOZZLE FOR A LASER PROCESSING SYSTEM

(71) Applicant: Hypertherm, Inc., Hanover, NH (US)

(72) Inventors: Kenneth Woods, Hanover, NH (US); Brenda Melius, Hanover, NH (US); Takayuki Hirano, Hoffman Estates, IL (US); Ryan Conroy, Schaumburg, IL (US); Henry White, Belvidere, IL (US)

(21) Appl. No.: 17/983,173

(22) Filed: Nov. 8, 2022

Related U.S. Application Data
(60) Provisional application No. 63/276,792, filed on Nov. 8, 2021.
(60) Provisional application No. 63/401,224, filed on Aug. 26, 2022.

(51) Int. Cl. B23K 26/14

(52) U.S. Cl. CPC B23K 26/1476; B23K 26/38

(57) ABSTRACT

A nozzle for a laser processing head is provided. The nozzle includes a primary passage disposed in a body of the nozzle. The primary passage is configured to direct a laser beam and a primary fluid from a proximal end of the body to a distal end of the body. The nozzle also includes a set of at least one auxiliary passage disposed in the body of the nozzle and radially offset from a longitudinal axis of the primary passage. A distal portion of the auxiliary passage diverts into two fluid flow passages including (i) a first fluid flow passage configured to direct a first portion of an auxiliary fluid axially forward toward the distal end of the nozzle body, and (ii) a second fluid flow passage configured to direct a second portion of the auxiliary fluid radially inward to mix with the primary fluid in the primary passage.

### CROSS REFERENCE TO RELATED APPLICATION

This application claims the benefit of and priority to U.S. Provisional Pat. Application Nos. 63/276,792 filed on Nov. 8, 2021 and 63/401,224 filed on Aug. 26, 2022, the entire content of both of which are owned by the assignees of the instant application and incorporated herein by reference in their entireties.

### TECHNICAL FIELD

The present invention generally relates to one or more nozzle designs for a laser processing system.

### BACKGROUND

Material processing systems, including laser processing systems, liquid jet processing systems and plasma arc torch systems, are widely used for processing (e.g., heating, cutting, gouging and marking) of materials, such as metal sheets. A laser processing system generally includes a high-power laser, a gas stream, an optical system, and a computer controlled numeric system (CNC). In operation, laser processing systems use the gas stream to blow molten material away from a workpiece while controllably delivering the laser beam to the workpiece to process the workpiece. Laser processing systems are frequently used in precision cutting operations due to the ease of control provided by the laser beam, gas stream, and geometry of the laser nozzles.

In laser processing systems, the flow profile of the gas stream is determined by the operating pressure and physical characteristics of the nozzle geometry. Traditionally, the gas stream includes air, oxygen, nitrogen, argon, etc. or a mixture of two or more of these gases. Oxygen and compressed air are cheapest to use in a gas stream, but can oxidize the workpiece as they cut, thereby necessitating post-cut treatment such as chemical finishing or grinding. In situations where cutting materials tend to oxidize, it can be beneficial to use nitrogen or argon in the gas stream because they are generally inert and do not react with workpieces as they are being cut. Nitrogen and argon, however, are typically operated at very high pressures and flow rates, making them more expensive to use than oxygen, thus increasing the cost to operate a laser processing system.

One way to alter the flow profile of a gas stream of a laser processing system is to increase the velocity and pressure profile of the peripheral region of the laser cutting nozzle in relation to the central region. However, this is difficult because both the peripheral and central regions are typically fed by the same plenum. In the case where the two regions are fed with different pressures or gases, the gap between the nozzle and the workpiece can create a region of uniform static pressure, especially if the gap is small, consequently minimizing the influence of the differential feeding parameters. Further, if the pressures in the peripheral and central regions of the nozzle are different, there can be a backflow of gas into the lower pressure region within the nozzle, which can create spatter that is harmful to the nozzle. This is particularly harmful where the spatter is channeled through the central region of the nozzle, as the optical lens can be damaged or the nozzle can be blocked, leading to decreased cut quality and overall lifespan of the laser consumables.

Thus, there is a need for nozzles of laser processing systems that can improve control over pressure and velocity flow profiles of gas streams of these systems to achieve desired cuts.

### SUMMARY

The present invention, in some embodiments, provides a nozzle for laser cutting applications that is configured to passively mix a primary fluid (e.g., a gas) with a portion of a second fluid (e.g., a gas) within the nozzle. The resulting nozzle design improves control over the pressure and velocity profiles of the gas stream in the region between the nozzle end face and a workpiece to achieve desired cuts in the workpiece. In some embodiments, a nozzle of the present invention is configured to create multiple fluid flow passages that remain disparate from each other while one or more of these passages are introduced to the ambient environment by venting, which allows for mixing of gases, varying of pressures, or both. These multiple passages permit greater control of cutting variables, which leads to more controlled cuts with improved cut quality at lower operating costs.

In one aspect, a nozzle for a laser processing head is provided for processing a workpiece. The nozzle comprises a primary passage disposed in a body of the nozzle. The primary passage is configured to direct a laser beam and a primary fluid from a proximal end of the body to a distal end of the body to process the workpiece. The nozzle also comprises a set of at least one auxiliary passage disposed in the body of the nozzle and radially offset from a longitudinal axis of the primary passage. A distal portion of the at least one auxiliary passage diverts into two fluid flow passages includes a first fluid flow passage configured to direct a first portion of an auxiliary fluid axially forward toward the distal end of the nozzle body to substantially shroud the laser beam emerging from the primary passage and a second fluid flow passage configured to direct a second portion of the auxiliary fluid radially inward to mix with the primary fluid in the primary passage.

In another aspect, a method is provided for mixing at least two fluids within a nozzle for a laser processing head of a laser processing system. The method includes directing a primary fluid axially forward through a primary passage disposed in a body of the nozzle from a proximal end to a distal end of the body and providing an auxiliary fluid into at least one auxiliary passage disposed in the body of the nozzle. A distal portion of the auxiliary passage is configured to divert into a first fluid flow passage and a second fluid flow passage. The method also includes directing a first portion of the auxiliary fluid axially forward through the first fluid flow passage of the auxiliary passage toward the distal end of the nozzle body, directing a second portion of the auxiliary fluid inward through the second fluid flow passage of the auxiliary passage toward the primary fluid in the primary passage, and mixing the second portion of the auxiliary fluid with the primary fluid in the primary passage to create a mixed processing fluid.

In yet another aspect, a nozzle for a laser processing head is provided for processing a workpiece. The nozzle comprises a primary passage disposed in a body of the nozzle. The primary passage is configured to direct a laser beam and a primary fluid from a proximal end of the body to a distal end of the body to process the workpiece. The nozzle also includes a set of at least one auxiliary passage disposed in the body of the nozzle. A distal portion of the at least one auxiliary passage configured to divert into two fluid flow passages including (i) a first fluid flow passage configured to direct a first portion of an auxiliary fluid in an axially forward direction toward the distal end of the nozzle body to substantially shroud the laser beam emerging from the primary passage, and (ii) a first fluid flow passage configured to direct a first portion of an auxiliary fluid in an axially forward direction toward the distal end of the nozzle body to substantially shroud the laser beam emerging from the primary passage. The nozzle also includes a set of at least one vent passage extending outward from the primary passage to fluidly connect the primary passage to atmosphere.

Any of the above aspects can include one or more of the following features. In some embodiments, the first fluid flow passage directs the first portion of the auxiliary fluid forward towards the distal end of the body and the second fluid flow passage directs the second portion of the auxiliary fluid in a partially or substantially reverse direction towards the proximal end of the body (e.g., substantially axially opposite of a direction of the primary fluid in the primary passage). In some embodiments, the second fluid flow passage is angled between about 15 degrees and about 75 degrees in relation to the first fluid flow passage. In some embodiments, the primary fluid and the auxiliary fluid are gases.

In some embodiments, the set of at least one auxiliary passage includes at least three distinct auxiliary passages circumferentially disposed about the primary passage in the nozzle body. In some embodiments, the at least one auxiliary passage has a rectangular cross section. In some embodiments, the primary passage has a cross-sectional area of between 0.78 mm² and 19.6 mm², and the auxiliary passage has a cross-sectional area of between 5.5 mm² and 40 mm². In some embodiments, a ratio of a cross-sectional area of the primary passage to a cross-sectional area of the auxiliary passage is less than about 8.

In some embodiments, a set of at least one vent passage is provided that extends outward from the primary passage to fluidly connect the primary passage to atmosphere. In some embodiments, the at least one vent passage is oriented substantially perpendicular to at least one of the primary passage or the first fluid flow passage of the at least one auxiliary passage. In some embodiments, the at least one vent passage is at a location axially distal relative to the second fluid flow passage. In some embodiments, the at least one vent passage is fluidly isolated from the first fluid flow passage.

In some embodiments, the nozzle is a double nozzle including an inner body and an outer body, wherein (i) the inner body includes the second fluid flow passage and (ii) the outer body, in cooperation with the inner body, define the first fluid flow passage. In some embodiments, the nozzle is a triple nozzle that further comprises an insert disposed within the inner body. In some embodiments, an insert is disposed in the primary passage proximate to the proximal end of the body of the nozzle. In some embodiments, the insert comprises at least one foot, an inner orifice and a set of shower holes disposed about the inner orifice. In some embodiments, a mixing chamber is disposed in the primary passage between the inner orifice of the insert and an exit orifice of the nozzle. The mixing chamber is in fluid communication with the first fluid flow passage of the auxiliary passage. In some embodiments, a vent chamber is located between the mixing chamber and the exit orifice, the vent chamber having a smaller volume than that of the mixing chamber.

In some embodiments, a laser beam is directed axially forward through the primary passage and the laser beam is ejected along with the mixed processing fluid from the primary passage at the distal end of the nozzle. In some embodiments, the first portion of the auxiliary fluid is ejected from the first flow passage of the auxiliary passage at the distal end of the nozzle to substantially shroud the laser beam as the laser beam emerges from the primary passage.

In some embodiments, the primary fluid has a pressure of between about 60 pound per square inch (psi) and about 300 psi when entering the primary passage from the proximal end of the nozzle. In some embodiments, the auxiliary fluid has a pressure of between about 30 psi and about 300 psi when entering the auxiliary passage from the proximal end of the nozzle.

In some embodiments, the primary fluid is constricted prior to mixing the primary fluid with the second portion of the auxiliary fluid. In some embodiments, the mixed processing fluid is constricted prior to expelling the mixed processing fluid from the primary passage.

In yet another aspect, a method is provided for mixing at least two fluids within a nozzle for a laser processing head of a laser processing system. The method includes directing a primary fluid axially forward through a primary passage disposed in a body of the nozzle from a proximal end to a distal end of the body, providing an auxiliary fluid into at least one auxiliary passage disposed in the body of the nozzle, directing at least a portion of the auxiliary fluid inward by the auxiliary passage toward the primary fluid in the primary passage, and mixing the at least portion of the auxiliary fluid with the primary fluid in the primary passage to create a mixed processing fluid.

In yet another aspect, a nozzle for a laser processing head for processing a workpiece is provided. The nozzle comprises a body, a primary passage disposed in the body, and at least one auxiliary passage disposed in the body. The primary passage is configured to direct a laser beam and a primary fluid from a proximal end of the body to a distal end of the body. The at least one auxiliary passage is configured to direct at least a portion of an auxiliary fluid toward a path of the primary fluid to mix the portion of the auxiliary fluid with the primary fluid in the body of the nozzle.

In some embodiments, a distal portion of the auxiliary passage is configured to divert into a first fluid flow passage and a second fluid flow passage. In some embodiments, a second portion of the auxiliary fluid is directed axially forward through the first fluid flow passage of the auxiliary passage toward the distal end of the nozzle body. In some embodiments, the at least portion of the auxiliary fluid is directed inward toward the primary fluid by the second fluid flow passage of the auxiliary passage.

In some embodiments, directing the at least portion of the auxiliary fluid inward comprises directing the at least portion along a direction substantially axially opposite of a direction of the primary fluid in the primary passage. In some embodiments, the second fluid flow passage is angled between about 15 degrees and about 75 degrees in relation to the first fluid flow passage.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 shows a side sectional view of an exemplary nozzle for a laser processing system, according to some embodiments of the present invention.

FIG. 2 shows another side sectional view of the nozzle of FIG. 1, according to some embodiments of the present invention.

FIGS. 3a-d show planar sectional views of the nozzle of FIGS. 1 and 2 taken at various planes perpendicular to the longitudinal axis A of the nozzle, according to some embodiments of the present invention.

FIG. 4 shows an exemplary flow pattern of the primary and secondary/auxiliary fluids through the nozzle of FIGS. 1 and 2, according to some embodiments of the invention.

FIG. 5 shows an exemplary method for mixing the primary and auxiliary fluids within the nozzle of FIGS. 1 and 2, according to some embodiments of the present invention.

FIGS. 6a and 6b show an exemplary pressure profile 600 and a refined version of the pressure profile 600, respectively, within the nozzle 100 of FIGS. 1 and 2 during a laser cutting operation, according to some embodiments of the present invention.

FIG. 7 shows an exemplary computational flow dynamics (CFD) pressure profile of the nozzle of FIGS. 1 and 2 during a laser cutting operation, according to some embodiments of the present invention.

FIG. 8 shows a side sectional view of another exemplary nozzle for a laser processing system, according to some embodiments of the present invention.

### DETAILED DESCRIPTION

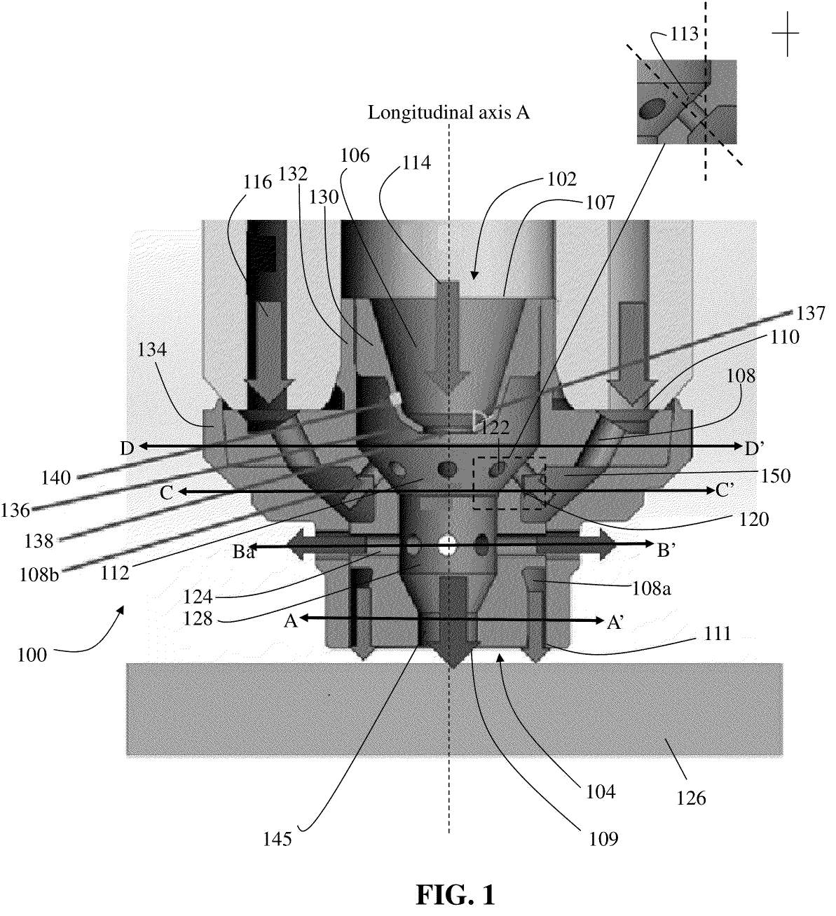

FIG. 1 shows a side sectional view of an exemplary nozzle 100 for a laser processing system, according to some embodiments of the present invention. As shown, the nozzle 100 comprises a body having a proximal end 102 and a distal end 104 along a central longitudinal axis A of the body, where the distal end 104 is defined as the end that is closest to a workpiece 126 during operation of the laser processing system and the proximal end 102 is opposite of the distal end 104 along the longitudinal axis A.

A primary passage 106 is disposed in the body of the nozzle 100, substantially extending between a proximal opening 107 at the proximal end 102 of the nozzle body and a distal opening 109 at the distal end 104 of the nozzle body along the central longitudinal axis A. The primary passage 106 is configured to receive a primary fluid (e.g., a gas, a liquid, or a mixture of both) via its proximal opening 107 and deliver, via its distal opening 109, a laser beam along with a mixture of the primary fluid and at least one auxiliary fluid to the workpiece 126 (e.g., a metal) for processing the workpiece 126. In some embodiments, an internal mixing chamber 112 is located along the primary passage 106 between the proximal opening 107 and the distal opening 109 of the primary passage 106.

As shown, a set of at least one auxiliary passage 108 is disposed in the body of the nozzle 100, where each auxiliary passage 108 has a proximal opening 110 that is radially offset from the longitudinal axis of the primary passage 106. Each auxiliary passage 108 is configured to direct an auxiliary fluid (e.g., a gas, a liquid, or a mixture of both) through the nozzle 100 for processing the workpiece 126. In some embodiments, each auxiliary passage 108 is in fluid communication with a circumferential auxiliary fluid chamber 150 disposed in the nozzle body substantially surrounding the primary passage 106. The circumferential auxiliary fluid chamber 150 is configured to receive the auxiliary fluid from the set of one or more auxiliary passages 108 and split the auxiliary fluid between a set of one or more forward auxiliary passages 108a and a set of one or more reverse auxiliary passages 108b. Therefore, a distal portion of each auxiliary passage 108 diverts into at least one of the set of forward fluid flow passages 108a and at least one of the set of reverse fluid flow passages 108b.

Each forward auxiliary passage 108a is configured to direct a portion of the auxiliary fluid (received from the auxiliary passage(s) 108) axially forward toward the distal end 104 of the body of the nozzle 100. The forward auxiliary passage(s) 108a can eject the auxiliary fluid from the nozzle 100 via their respective distal openings 111 at the distal end 104 of the nozzle body to substantially shroud the laser beam and the mixed fluid emerging from the primary passage 106 via the distal opening 109 of the primary passage 106.

Each reverse auxiliary passage 108b has an inlet 120 in fluid communication with the circumferential auxiliary fluid chamber 150 (which fluidly connects the reverse auxiliary passage 108b with the set of main auxiliary passages 108 as well as with the set of forward auxiliary passages 108a) and an outlet 122 in fluid communication with the mixing chamber 112 of the primary passage 106. Each reverse auxiliary passage 108b is configured to direct another portion of the auxiliary fluid (received from the auxiliary passage(s) 108) radially inward to mix with the primary fluid in the mixing chamber 112 of the primary passage 106.

In some embodiments, the mixing chamber 112 of the primary passage 106 is located axially proximal to the circumferential auxiliary fluid chamber 150 at which point the main auxiliary passages 108 split into the forward and reverse auxiliary passages 108a, 108b. Thus, each reverse auxiliary passage 108b can be configured to direct the auxiliary fluid to the mixing chamber 112 in a substantially reverse/opposite direction in relation to the fluid flow in the primary passage 106, while directing the auxiliary fluid inward toward the primary passage 106. In some embodiments, each reverse auxiliary passage 108b maintains an angle 113 (shown as an inset of FIG. 1) of between about 0 to about 90 degrees, such as between about 15 degrees and about 75 degrees, in relation to the forward auxiliary passage 108a. Such reverse flow geometry of the reverse auxiliary passage 108b is advantageous because it can enhance the mixing properties of the primary and auxiliary fluids in the mixing chamber 112 given the limited space present within the nozzle 100. In some embodiments, the reverse flow through each reverse auxiliary passage 108b is achieved by manipulating the relative fluid pressures at the proximal opening 107 of the primary passage 106 and/or the proximal opening 110 at each auxiliary passage 108. In some embodiments, the combined area of the proximal openings 110 at all the auxiliary passages 108 in the nozzle 100 can be greater than the total area of the inlets 120 of the reverse auxiliary passages 108b so as to allow the fluid flow of the main auxiliary passages 108 to sufficiently supply auxiliary fluid to both the forward and reverse auxiliary passages 108a, 108b.

In some embodiments, the mixing chamber 112 is configured to substantially mix the primary fluid received from the proximal opening 107 of the primary passage 106 and the auxiliary fluid received from the set of reverse auxiliary passage(s) 108b to generate a mixed fluid. The mixed fluid is subsequently constricted as it flows distally through the primary passage 106 and ejected from the nozzle 100 (along with the laser beam) via the distal opening 109 of the primary passage 106 to contact and process the workpiece 126. In some embodiments, the mixing of the primary and auxiliary fluids in the mixing chamber 112 occurs inside of the cutting head of the laser processing system within 2 feet of the nozzle bore 145proximate to the workpiece 126.

In some embodiments, two separate fluid supply lines 114, 116 are in fluid communication with respective ones of the proximal opening 107 of the primary passage 106 and the proximal opening(s) 110 of the set of one or more auxiliary passages 108 to deliver two separate fluids (e.g., gases) to each type of passage in the nozzle 100. More specifically, the fluid supply line 114 can provide the primary fluid to the primary passage 106 via the proximal opening 107. The fluid supply line 116 can provide an auxiliary fluid to the set of one or more auxiliary passages 108 via their respective proximal openings 110. In some embodiments, one or both of the primary and auxiliary fluids are gases. Exemplary primary fluids include nitrogen, oxygen, air, argon, methane, hydrogen, etc. The primary and auxiliary fluids can be the same or different. In some embodiments, the fluid supply lines 114, 116 are independently controlled to provide fluid flows with independent flow parameters, such as pressures, velocities and/or flow rates. As an example, the supply line 114 can supply the primary fluid at a pressure of between about 60 pounds per square inch (psi) and about 300 psi when entering the primary passage 106 via the proximal opening 107. The supply line 116 can supply the auxiliary fluid at a pressure of between about 30 pounds per square inch (psi) and about 300 psi when entering the set of one or more auxiliary passages 108 via their respective proximal openings 110. As described above, the nozzle 100 can be configured to mix these fluids at appropriate concentrations (e.g., at the mixing chamber 112 of the primary passage 106) to achieve the desired cutting operation by the laser processing system. In some embodiments, one or more of the auxiliary passages 108a, 108b and the primary passage 106 are shaped to induce pressure drops and/or adjust a characteristic (e.g., pressure value, flow rate, etc.) of the fluid flows through the nozzle 100, such as between the proximal end 102 and the distal end 104 of the nozzle 100.

In some embodiments, one or more of the auxiliary passages 108a, 108b and the primary passage 106 are in communication with the ambient environment (e.g., in contact with air outside of the nozzle assembly 100) via one or more vent passages 124 located upstream from the distal opening 109 of the primary passage 106. In some embodiments, the set of one or more vent passages 124 are isolated from direct interaction with the forward auxiliary flow passage(s) 108a. Further, the vent passages 124 can control one or more properties, such as static pressures, flow rates, and/or mixture concentrations, of the primary passage 106 and the auxiliary passages 108a, 108b when these passages are supplied by the same or different fluids, and at same or different operating parameters (e.g., operating pressures).

FIG. 1 shows an exemplary configuration of the nozzle 100 that includes a set of at least one vent passage 124 extending outward from the primary passage 106 to fluidly connect the primary passage 106 to an environment external to the nozzle 100 (e.g., atmosphere). This allows the pressure of the fluid flow in the primary passage 106 to remain positive, even as the pressure between the nozzle 100 and the workpiece 126 trends to zero, as explained in more detail below. As shown, each vent passage 124 can be connected to and extend outward from a vent chamber 128 of the primary passage 106, where the vent chamber 128 is located distal relative to the mixing chamber 112 (and the set of reverse auxiliary passages 108b), but proximal to the distal opening 109 of the primary passage 106. Each vent passage 124 can also be located axially distal relative to (i.e., downstream from) the mixing chamber 112 and/or the reverse auxiliary passage 108b. In some embodiments, the vent chamber 128 has a smaller volume than that of the mixing chamber 112. Each vent passage 124 can be oriented substantially perpendicular to at least one of the primary passage 106 or the forward auxiliary passage 108a (both of which can extend substantially parallel to the longitudinal axis A). Even though the vent passages 124 of FIG. 1 are shown projecting perpendicularly relative to longitudinal axis A, these vent passages 124 can also be canted/angled relative to longitudinal axis A. In some embodiments, these vent passages 124 are located axially proximal to the reverse auxiliary passage(s) 108b, instead of axially distal as illustrated.

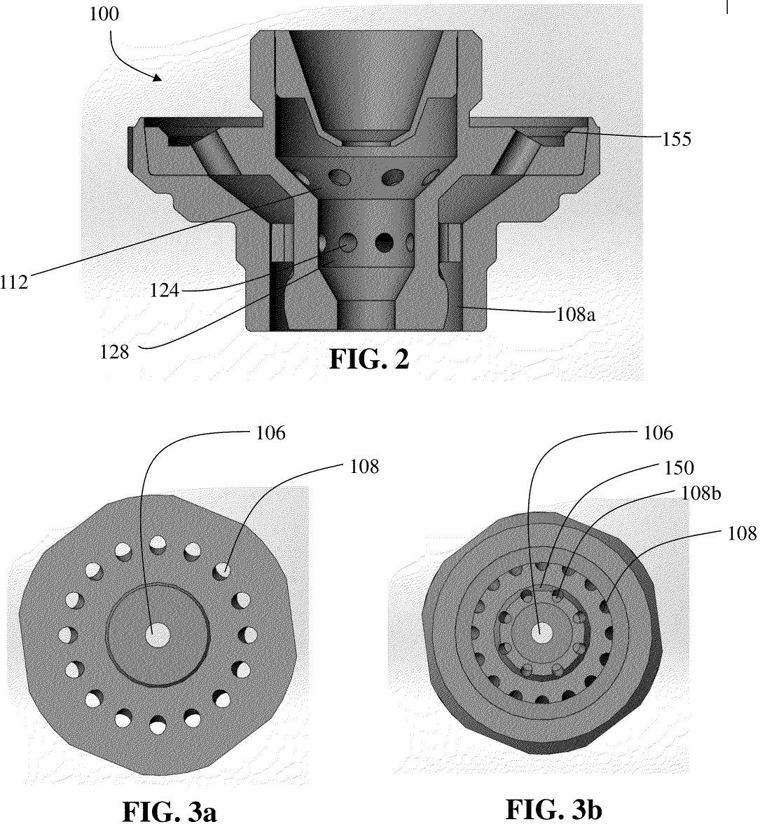

In some embodiments, each vent passage 124 can be fluidly isolated/disparate from the forward auxiliary passages 108a, allowing only the primary passage 106 and/or the reverse auxiliary passages 108b to be in communication with the ambient environment. FIG. 2 shows another side sectional view of the nozzle 100 of FIG. 1, according to some embodiments of the present invention. FIGS. 1 and 2 when taken together show two perspective cutaways of the same vented nozzle 100, with FIG. 2 rotated about the longitudinal axis A to a location of no vent passage 124. The angle of rotation can be about 22.5 degrees from FIG. 1 to FIG. 2. FIG. 2 clearly illustrates that the forward auxiliary passages 108a are not in fluid communication with the vent passages 124. However, in alternative embodiments the vent passages 124 can extend/project from the forward auxiliary flow passages 108a in addition to or instead of from the primary passage 106.

In some embodiments, the nozzle 100 of FIGS. 1 and 2 is a triple nozzle comprising an insert 130, an inner body 132 and an outer body 134. The three layers can be concentrically nested with the insert 130 substantially disposed inside the inner body 132, and the combination of which substantially disposed inside of the outer body 134. In some embodiments, the insert 130 comprises at least one foot 136 oriented inward at an angle 137 and an inner orifice 138. In some embodiments, the insert 130 additionally includes a set of shower holes (not shown) disposed about the inner orifice 138. The insert 130 can be located within the primary passage 106 proximate to the proximal end 102 of the nozzle 100. The mixing chamber 112 is also disposed within the primary passage 106 between the inner orifice 138 of the insert 130 and the distal opening 109 of the primary passage 106. In some embodiments, the inner body 132 defines at least a portion of the primary passage 106. In some embodiments, the reverse auxiliary passages 108b are located on the inner body 132 such that each reverse auxiliary passage 108b extends from an interior surface to an exterior surface of the inner body 132. In some embodiments, the inner body 132 and the outer body 134 cooperatively define the forward auxiliary passages 108a therebetween. In some embodiments, the nozzle 100 is configured as a double nozzle with the insert 130 removed, thereby comprising only the inner body 132 and the outer body 134. In some embodiments, advanced manufacturing methods, such as 3D printing, is utilized to realize similar geometries and features in a single piece construction. In some embodiments, as shown in FIG. 2, the nozzle 100 includes an alignment feature 155 to indicate an installation alignment datum on the body of the nozzle 100 for allowing optimized alignment to the nozzle bore 145.

In some embodiments, the vent passages 124 are compatible with the double or triple design of the nozzle 100. The vent passages 124 permit a substantially larger design space for the sizes of the inner nozzle body 132 and the outer nozzle body 134, pressures, and more uniform flow as the distance between the nozzle 100 to workpiece 126 varies. In some embodiments, the vent passages 124 allow the velocity of the fluid flows to be positive within the nozzle 100, even as the nozzle-to-workpiece distance approaches zero. To keep the pressure positive, the overall amount of fluid (e.g., the combination of primary and secondary fluids) supplied to the nozzle 100 needs to be greater, and the increase in fluid supply can be provided by the auxiliary fluid fed to the auxiliary passages 108 using a less expensive fluid. Additionally, the vent passages 124 help prevent negative axial pressure gradients in the flow passages as the gap distance between the distal end 104 of the nozzle 100 and the workpiece 126 decreases. Negative axial pressure gradients are generally undesirable as they can cause fluids to backflow into one or more of the flow passages, which can allow material spatter to adhere to the nozzle 100 or plug the flow passages, or worse yet, contaminate the laser optics, which can greatly decrease the life of the laser optics and processing stability.

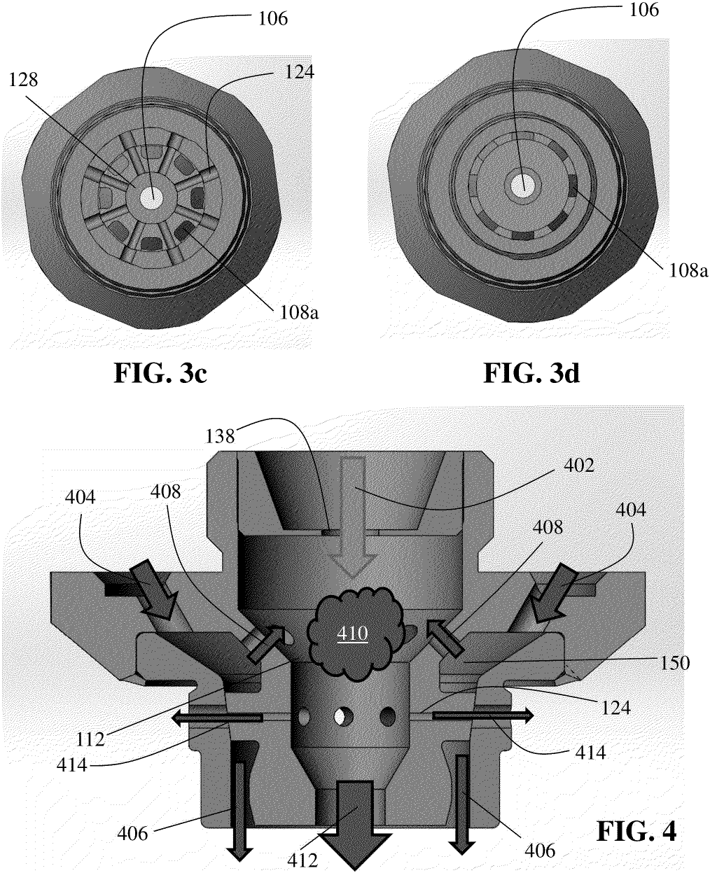

FIGS. 3a-d show planar sectional views of the nozzle 100 of FIGS. 1 and 2 taken at various planes perpendicular to the longitudinal axis A of the nozzle 100, according to some embodiments of the present invention. As shown in FIG. 3a, which is a sectional view of the nozzle 100 taken at the radial plane D-D′ indicated in FIG. 1, the nozzle 100 can include 16 auxiliary passages 108 circumferentially disposed around the central primary passage 106. In some embodiments, the primary passage 106 has a cross-sectional area of between about 0.78 mm² and about 19.6 mm². In some embodiments, each of the auxiliary passages 108 has a cross-sectional area of between about 0.55 mm² and about 40 mm². In some embodiments, a ratio of the cross-sectional area of the primary passage 106 to the cross-sectional area of a single auxiliary passage 108 is less than about 8. As an example, the diameter of each of the 16 auxiliary passages 108 can be about 1.5 mm with a total area of all 16 auxiliary passages of about 28.3 mm² (16^{∗}π^{∗}0.85 mm^{∗}0.85 mm). In alternative embodiments, the nozzle 100 can include fewer or more auxiliary passages 108, such 3, 6 or 24 auxiliary passages 108.

In some embodiments, as shown in FIG. 3b, which is a sectional view of the nozzle 100 taken at the radial plane C-C′ indicated in FIG. 1, the nozzle 100 can include 8 reverse auxiliary passages 108b in fluid communication with the circumferential auxiliary chamber 150, to which the 16 main auxiliary passages 108 are also connected. In some embodiments, each reverse auxiliary passage 108b has a diameter of about 1.2 mm with a total area of all 8 reverse auxiliary passages 108b of about 9 mm² (8^{∗}π^{∗}0.6 mm^{∗}0.6 mm). Thus, in the configuration of the nozzle 100 illustrated in FIGS. 3a-d, the total area of the main auxiliary passages 108 is much greater than the total area of the reverse auxiliary passages 108b. In alternative embodiments, the nozzle 100 can include fewer or more reverse auxiliary passages 108b, such as 4 or 16 reverse auxiliary passages 108b.

In some embodiments, as shown in FIG. 3c, which is a sectional view of the nozzle 100 taken at the radial plane B-B′ indicated in FIG. 1, the nozzle 100 can include a set of 8 vent passages 124 extending outward from the vent chamber 128 of the primary passage 106 to fluidly connect the primary passage 106 to atmosphere. In general, there may be more or fewer vent passages 124 of differing shapes, sizes, or spacing, as required to achieve the desired operating velocity and pressure profiles in the primary and secondary fluids. As shown, the vent passages 124 are fluidly isolated from the forward auxiliary passages 108a.

In some embodiments, as shown in FIG. 3d, which is a sectional view of the nozzle 100 taken at the radial plane A-A′ indicated in FIG. 1, the nozzle 100 can include a set of 8 forward auxiliary passages 108a dispersed around the primary passage 106. In alternative embodiments, the nozzle 100 can include fewer or more forward auxiliary passages 108a, such as 4 or 16 forward auxiliary passages108b. Even though FIGS. 3a-d illustrate the primary passage 106, the auxiliary passages 108, the forward auxiliary passages 108a, the reverse auxiliary passages 108b and the vent passages 124 as having a circular cross section, in alternative embodiments, these passages can have a different cross-sectional shape, such as a rectangular cross section.

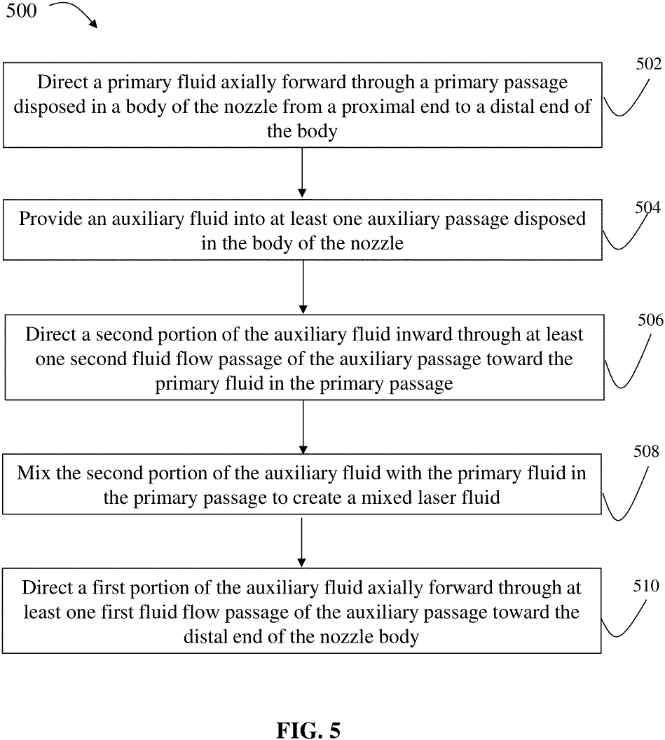

FIG. 4 shows an exemplary flow pattern of the primary and secondary/auxiliary fluids through the nozzle 100 of FIGS. 1 and 2, according to some embodiments of the invention. FIG. 5 shows an exemplary method 500 for mixing the primary and auxiliary fluids within the nozzle 100 of FIGS. 1 and 2, according to some embodiments of the present invention. The method 500 of FIG. 5 can be explained in the context of the fluid flow pattern illustrated in FIG. 4. At step 502 of the method 500, a primary fluid is directed to the proximal opening 107 of the primary passage 106 of the nozzle 100 located at the proximal end 102 of the nozzle body. The primary fluid can be supplied by the input line 114. The primary fluid is adapted to flow axially forward (along path 402 of FIG. 4) through the primary passage 106 toward the mixing chamber 112 of the primary passage 106. At step 504, an auxiliary fluid is directed to the proximal opening 110 of each auxiliary passage 108 in the set of one or more auxiliary passages 108 disposed in the nozzle body around the primary passage 106. The auxiliary fluid can be supplied by the input line 116 that is independently controllable and operable from the primary input line 114. The auxiliary fluid is adapted to flow axially forward (along path 404 of FIG. 4) through each of the one or more auxiliary passages 108 toward the circumferential auxiliary fluid chamber 150. Upon reaching the circumferential auxiliary fluid chamber 150, the auxiliary fluid supplied by the set of one or more auxiliary passages 108 is adapted to divert/split into a set of forward fluid flow passages 108a and a set of one or more reverse fluid flow passages 108b.

At step 506, a portion of the auxiliary fluid provided by the set of auxiliary passages 108 is directed by each of the reverse fluid flow passages 108b to flow radially inward (along path 408 of FIG. 4) toward the primary fluid in the mixing chamber 112 of the primary passage 106. For example, the reverse auxiliary passages 108b can direct the auxiliary fluid radially inward into the path of the primary fluid while also along a direction substantially axially opposite of the direction of the primary fluid flow in the primary passage 106 (i.e., axially backward). At step 508, the mixing chamber 112 is configured to mix the portion of the auxiliary fluid received from the one or more reverse fluid flow passages 108b with the primary fluid in the primary passage 106 to create a mixed processing fluid (mixture 410 of FIG. 4). In some embodiments, the primary fluid in the primary passage 106 is constricted prior to being mixed with the auxiliary fluid. For example, the inner orifice 138 of the insert 130 can provide the constriction on the primary fluid as it enters the primary passage 106. In some embodiments, the mixed processing fluid, along with a laser beam (not shown) of the laser processing system is directed axially forward (along path 412 of FIG. 4) through the primary passage 106. The combination of the mixed processing fluid and the laser beam can be ejected from the primary passage 106 via the distal opening 109 of the primary passage 106 to reach the workpiece 126 for processing the workpiece 126. In some embodiments, the mixed processing fluid is constricted prior to being expelled from the primary passage 106. For example, the narrowing of the nozzle bore 145 in the primary passage 106 adjacent to the distal opening 109 of the primary passage 106 can provide such constriction.

At step 510, another portion of the auxiliary fluid provided by the set of auxiliary passages 108 is directed by each of the forward fluid flow passages 108a to flow axially forward (along path 406 of FIG. 4) toward the distal end 104 of the nozzle body. This portion of the auxiliary fluid can be ejected from the forward fluid flow passages 108a via their respective distal openings 111 to substantially shroud the laser beam and the mixed processing fluid as they emerge from the distal opening 109 of the primary passage 106 (e.g., as a shroud or shield gas). As shown in FIG. 4, the path 406 of the auxiliary fluid flow in the forward auxiliary passages 108a can be substantially parallel to the path 412 of the mixed fluid and laser beam flow in the primary passage 106.

In some embodiments, a portion of the mixed processing fluid in the primary passage 106 is vented to atmosphere via the set of one or more radial vent passages 124 (along path 414 of FIG. 4) before the mixed fluid is ejected from the nozzle 100 via the distal opening 109. Each vent passage 124 can be connected to and extend outward from the vent chamber 128 of the primary passage 106 located distal to the mixing chamber 112. In some embodiments, the portion of the mixed processing fluid vented is fluidly isolated from the auxiliary fluid in the forward fluid flow passage(s) 108a. Therefore, paths 406 and 414 are fluidly isolated from each other.

In general, the flow directions of the fluids through the nozzle 100 (e.g., through the vent passages 124, the forward passages 108a and the reverse passages 108b) is dependent on the relative pressures of the primary and auxiliary fluids provided to their respective proximal openings 107, 111 and the relative geometrical features (e.g., passage opening sizes, number, locations, angles, induced pressure drops, etc.). These operating parameters and geometric features can be controlled and adjusted accordingly to achieve the desired cutting results. In some embodiments, even though the nozzle 100 is described in relation to two fluids (i.e., primary and auxiliary fluids), a person of ordinary skill in the art understands that the nozzle 100 can be easily designed to accommodate the flow and mixing of additional fluids, such as tertiary and/or quaternary fluids and beyond. In various embodiments, the fluids mixed by the nozzle 100 can be liquids, gases, or a combination of one or more gases and one or more liquids (e.g., misting). In some embodiments, the nozzle 100 is constructed from the same material. Alternatively, the nozzle 100 can utilize multiple materials or parts to achieve the desired results.

In some embodiments, such mixing of processing fluids in the nozzle 100 as described above can occur in a different location of the laser processing system, such as in the nozzle holder or thereabout. For example, portions of the auxiliary fluid can be introduced and/or mixed to the primary fluid flow within about 2 feet of the nozzle bore 145 (e.g., proximate the workpiece, inside the cutting head, etc.). In these embodiments, portions of the auxiliary fluid can be introduced/injected into the primary fluid flow via features in the cutting head, the nozzle holder, and/or the nozzle 100 itself. In some embodiments, a first portion of auxiliary fluid flow is introduced to the primary fluid flow in the cutting head, a second portion of auxiliary flow is introduced to the primary fluid flow via features (e.g., passages/holes) in the nozzle holder, and a third portion of auxiliary flow is introduced to the primary flow via features in the nozzle 100. This staged introduction promotes mixing of the fluids. In some other embodiments, the auxiliary fluid is introduced only at one of these stages. In some embodiments, the auxiliary fluid (e.g., secondary, tertiary, quaternary, etc.) is introduced/mixed to the primary fluid proximal to the optical surfaces (e.g., laser lens).

In general, the various embodiments of the nozzle 100 described herein have a number of benefits, including the creation of a mixing region (e.g., the mixing chamber 112) that mixes an auxiliary fluid with a primary fluid proximate the workpiece 126 (e.g., mixing within 2 feet of the workpiece 126). The auxiliary fluid is provided by the outer auxiliary passages 108 and adapted to flow radially inward through the nozzle 100 to mix with the primary fluid in the mixing region of the inner primary passage 106 before being expelled via the distal opening 109 of the primary passage 106. Such passive mixing reduces and/or eliminates the need for a costly and large mixing system setup that is employed in existing laser processing systems. Another benefit comprises the greater control of pressure within the different passages of the nozzle 100. Venting within the nozzle 100 creates flow properties that enable the mixing region to mix the primary and secondary fluids. Generally, a vented nozzle consumes more overall fluid than a non-vented one, but the nozzle designs described above with the usage of auxiliary passages 108 and auxiliary fluid can support and reduce the usage of the primary fluid, which is typically more expensive that the auxiliary fluid. More specifically, the auxiliary passages can create a sheath of auxiliary fluid that shrouds around the generally more expensive primary fluid. This configuration increases robust processing, while using the minimal amount of primary fluid necessary for the required processing task.

Yet, another benefit involves the reduced cost associated with the mixing of the fluids in the nozzle designs described above. For laser processing, air can be the least expensive assist gas to use since it typically requires only electricity to operate and a compressor and filtration component to remove moisture, oils, and particulates. Nitrogen and oxygen are the next lowest cost option, but because of the high flow rates needed for high pressure laser processing, their associated operating costs can still be a major driver of consumable cost. As an example, liquid nitrogen is commonly used to supply assist gas for laser processing and can require flow rates of about 50 to about 100 standard cubic feet per minute (SCFM). At a nominal price of $1/liter for liquid nitrogen, this translates to an operating cost of $122-$244 per hour of consumption. In addition, the amount of burr on the bottom of a cut edge can be reduced or eliminated on certain materials when the total nitrogen concentration is at the proper level. However, the majority of the gas consumed is still nitrogen in this case, which incurs the high operating costs along with expensive equipment to mix the gases at the correct ratios. Additionally, as laser powers continue to increase, the demand on the optics and their cleanliness also increases requiring substantial maintenance on the filters for air used in a mixed gas since it is in contact with the optics. By introducing the system and method of gas mixing in the nozzle in the instant technology, such as using nitrogen as the primary fluid and air as the auxiliary fluid, the rate of nitrogen and/or oxygen consumption can be substantially reduced because the correct mix concentration is only required in a small processing zone (e.g., in the mixing chamber 112) and the remaining bulk flow can be comprised of lower cost air (e.g., the auxiliary fluid). Furthermore, high purity nitrogen (e.g., the primary fluid) can be introduced solely in the region in contact with the optics to maintain cleanliness, and lower quality air (e.g., the auxiliary fluid) can be utilized for delivery to the nozzle to be used for the mixing. As an example, the measurement of the required nitrogen flow rates in the mixing nozzle can be in the 9-12 SCFM range, a decrease of 80% or more from traditional flow rates, translating to a savings up to $195/hour of consumption. Hence, significant benefits are realized by mixing air and nitrogen at high nitrogen concentrations in a small processing zone when compared to using either nitrogen or air alone.

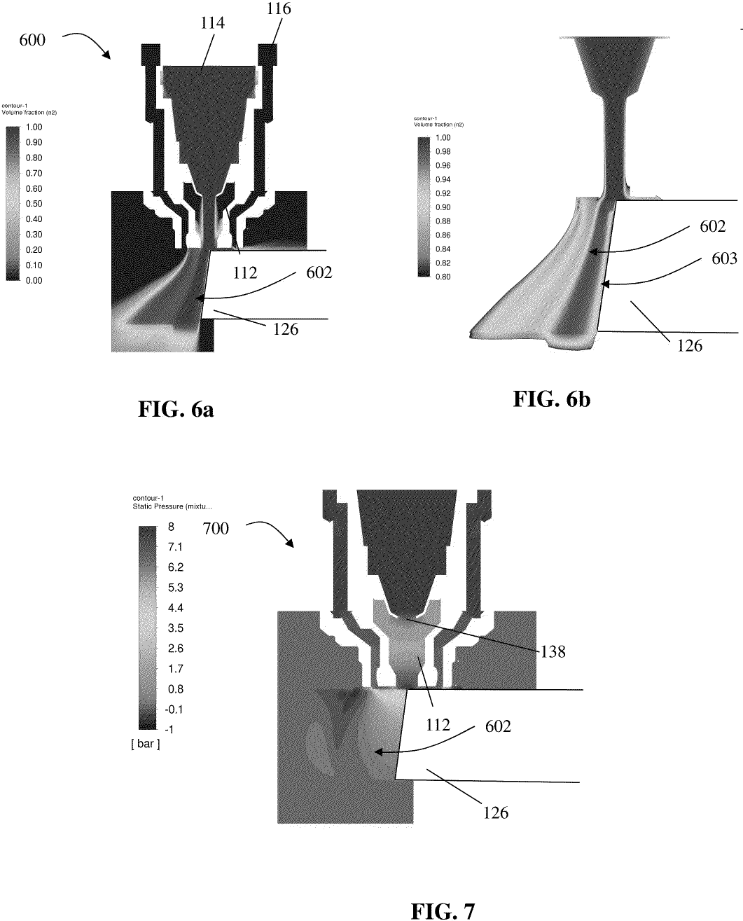

FIGS. 6a and 6b show an exemplary pressure profile 600 and a refined version of the pressure profile 600, respectively, within the nozzle 100 of FIGS. 1 and 2 during a laser cutting operation, according to some embodiments of the present invention. A secondary fluid provided by the supply line 116 in the form of a gas (represented by the blue color), such as oxygen or air, can be mixed with a primary fluid provided by the supply line 114 in the form of a gas (represented by the red color), such as nitrogen, to support the flow of the primary gas and alter the chemical processes in a processing region 602. The added support allows for an engineered combination of flow profile and gas composition to optimize cutting parameters and minimize operating cost. As can be seen in FIG. 6a, the primary and auxiliary gases are initially supplied by different sources via the supply lines 114, 116 and are subsequently mixed in the mixing chamber 112 of the nozzle 100, before the mixture flows into the processing region 602 along with the laser beam. The mixing of gases can assist in the cutting process by, for example, oxygenating the primary supply gas before it reaches the workpiece 126 and/or creating the proper concentration of gas mixture depending on the primary and auxiliary gas and/or fluid species in use. FIG. 6b is a refined view of the pressure profile 600 of FIG. 6a with the concentration range narrowed to illustrate the engineered concentration 603 between about 80% and about 90% in the critical processing zone. In some applications, oxygenation of the primary supply gas can be beneficial as oxygen often reacts exothermically with the material that is being cut, which can lead to increased cutting speeds while favorably altering other thermophysical properties such as the melt viscosity and surface tension. As is generally understood, different gases have different cutting properties depending on the material being cut.

FIG. 7 shows an exemplary computational flow dynamics (CFD) pressure profile 700 of the nozzle 100 of FIGS. 1 and 2 during a laser cutting operation, according to some embodiments of the present invention. As shown, the usage of the vent passages 124 allows the pressure to be higher around the peripheral region of the nozzle 100 when compared to the central region. This control gives the user the ability to modify the pressure of each of the peripheral and central regions individually by appropriately sizing the various passages in the nozzle 100 and/or adjusting a flow/pressure of the auxiliary and/or primary fluid flows. Traditionally, it has been difficult to provide a higher peripheral pressure in a nozzle without increasing the central pressure. The increased control provided by the vented nozzle designs described above enables optimization of the flow and pressure profiles for a given processing operation. However, one issue that can arise with different pressure regions within a nozzle is the possibility of backflow from a high pressure region to a low pressure region. This issue is particularly harmful when backflow is present in the central flow region (e.g., the primary passage 106) due to increased risk of optical contamination. This issue is circumvented in the vented nozzle 100 by the addition of vent passages 124 that divert excess pressure and still allow positive flow from the central flow region through the inner orifice 138.

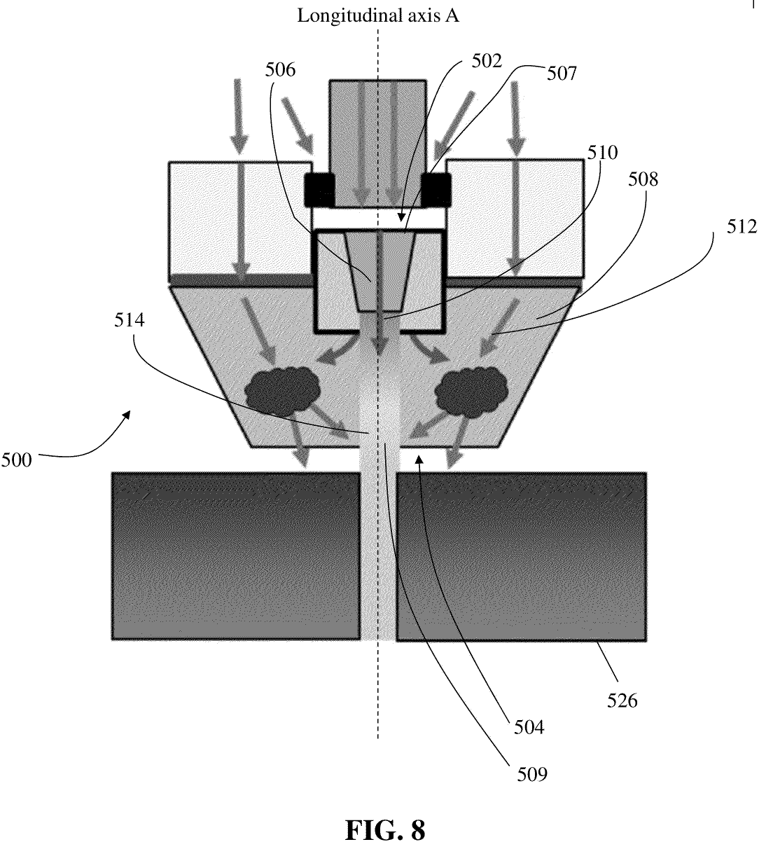

FIG. 8 shows a side sectional view of another exemplary nozzle 500 for a laser processing system, according to some embodiments of the present invention. As shown, the nozzle 500 comprises a body having a proximal end 502 and a distal end 504, where the distal end 504 is defined as the end that is closest to a workpiece 526 during operation of the laser processing system and the proximal end 502 is opposite of the distal end 504 along the longitudinal axis A.

A primary passage 506 is disposed in the body of the nozzle 500. The primary passage 506 is configured to receive a primary fluid 510 (e.g., a gas, a liquid, or a mixture of both) via its proximal opening 507. The body of the nozzle is configured to deliver, via its distal opening 509, a laser beam along with a mixture 514 of the primary fluid and at least one auxiliary fluid to the workpiece 526 (e.g., a metal) for processing the workpiece 526.

As shown, at least one auxiliary passage 508 is disposed in the body of the nozzle 500. Each auxiliary passage 508 is configured to direct at least a portion of an auxiliary fluid 512 (e.g., a gas, a liquid, or a mixture of both) toward the path of the primary fluid 510 to mix the portion of the auxiliary fluid 512 with the primary fluid 510 in the body of the nozzle before delivering the mixture 514 of the primary fluid and the portion of the auxiliary fluid to the workpiece 526.

It should be understood that various aspects and embodiments of the invention can be combined in various ways. Based on the teachings of this specification, a person of ordinary skill in the art can readily determine how to combine these various embodiments. Modifications may also occur to those skilled in the art upon reading the specification.

What is claimed is:

1. A nozzle for a laser processing head for processing a workpiece, the nozzle comprising:
a primary passage disposed in a body of the nozzle, the primary passage configured to direct a laser beam and a primary fluid from a proximal end of the body to a distal end of the body to process the workpiece; and
a set of at least one auxiliary passage disposed in the body of the nozzle and radially offset from a longitudinal axis of the primary passage, a distal portion of the at least one auxiliary passage diverts into two fluid flow passages including:
a first fluid flow passage configured to direct a first portion of an auxiliary fluid axially forward toward the distal end of the nozzle body to substantially shroud the laser beam emerging from the primary passage; and
a second fluid flow passage configured to direct a second portion of the auxiliary fluid radially inward to mix with the primary fluid in the primary passage.

2. The nozzle of claim 1, wherein (i) the first fluid flow passage directs the first portion of the auxiliary fluid forward towards the distal end of the body, and (ii) the second fluid flow passage directs the second portion of the auxiliary fluid in a substantially reverse direction towards the proximal end of the body.

3. The nozzle of claim 1, wherein the second fluid flow passage is angled between about 15 degrees and about 75 degrees in relation to the first fluid flow passage.

4. The nozzle of claim 1, wherein the set of at least one auxiliary passage includes at least three distinct auxiliary passages circumferentially disposed about the primary passage in the nozzle body.

5. The nozzle of claim 1, wherein the at least one auxiliary passage has a rectangular cross section.

6. The nozzle of claim 1, further comprising a set of at least one vent passage extending outward from the primary passage to fluidly connect the primary passage to atmosphere.

7. The nozzle of claim 6, wherein the at least one vent passage is oriented substantially perpendicular to at least one of the primary passage or the first fluid flow passage of the at least one auxiliary passage.

8. The nozzle of claim 6, wherein the at least one vent passage is at a location axially distal relative to the second fluid flow passage.

9. The nozzle of claim 6, wherein the at least one vent passage is fluidly isolated from the first fluid flow passage.

10. The nozzle of claim 1, wherein the nozzle is a double nozzle including an inner body and an outer body, wherein (i) the inner body includes the second fluid flow passage and (ii) the outer body, in cooperation with the inner body, define the first fluid flow passage.

11. The nozzle of claim 10, wherein the nozzle is a triple nozzle that further comprises an insert disposed within the inner body.

12. The nozzle of claim 1, wherein the primary fluid and the auxiliary fluid are gases.

13. The nozzle of claim 1, wherein the primary passage has a cross-sectional area of between 0.78 mm² and 19.6 mm², and the auxiliary passage has a cross-sectional area of between 5.5 mm² and 40 mm².

14. The nozzle of claim 1, wherein a ratio of a cross-sectional area of the primary passage to a cross-sectional area of the auxiliary passage is less than about 8.

15. The nozzle of claim 1, further comprising an insert disposed in the primary passage proximate to the proximal end of the body of the nozzle.

16. The nozzle of claim 15, wherein the insert comprises at least one foot, an inner orifice and a set of shower holes disposed about the inner orifice.

17. The nozzle of claim 16, further comprising a mixing chamber disposed in the primary passage between the inner orifice of the insert and an exit orifice of the nozzle, wherein the mixing chamber is in fluid communication with the first fluid flow passage of the auxiliary passage.

18. The nozzle of claim 18, further comprising a vent chamber located between the mixing chamber and the exit orifice, the vent chamber having a smaller volume than that of the mixing chamber.

19. A method of mixing at least two fluids within a nozzle for a laser processing head of a laser processing system, the method comprising:
directing a primary fluid axially forward through a primary passage disposed in a body of the nozzle from a proximal end to a distal end of the body;
providing an auxiliary fluid into at least one auxiliary passage disposed in the body of the nozzle, a distal portion of the auxiliary passage configured to divert into a first fluid flow passage and a second fluid flow passage;
directing a first portion of the auxiliary fluid axially forward through the first fluid flow passage of the auxiliary passage toward the distal end of the nozzle body;
directing a second portion of the auxiliary fluid inward through the second fluid flow passage of the auxiliary passage toward the primary fluid in the primary passage; and
mixing the second portion of the auxiliary fluid with the primary fluid in the primary passage to create a mixed processing fluid.

20. The method of claim 19, further comprising:
directing a laser beam axially forward through the primary passage; and
ejecting the laser beam along with the mixed processing fluid from the primary passage at the distal end of the nozzle.

21. The method of claim 20, further comprising ejecting the first portion of the auxiliary fluid from the first flow passage of the auxiliary passage at the distal end of the nozzle to substantially shroud the laser beam as the laser beam emerges from the primary passage.

22. The method of claim 19, wherein directing the second portion of the auxiliary fluid inward comprises directing the second portion along a direction substantially axially opposite of a direction of the primary fluid in the primary passage.

23. The method of claim 19, wherein the second fluid flow passage is angled between about 15 degrees and about 75 degrees in relation to the first fluid flow passage.

24. The method of claim 19, wherein the primary fluid has a pressure of between about 60 pound per square inch (psi) and about 300 psi when entering the primary passage from the proximal end of the nozzle.

25. The method of claim 19, wherein the auxiliary fluid has a pressure of between about 30 psi and about 300 psi when entering the auxiliary passage from the proximal end of the nozzle.

26. The method of claim 19, further comprising venting a portion of the mixed processing fluid to atmosphere via at least one radial vent passage disposed in the body of the nozzle.

27. The method of claim 26, wherein the portion of the mixed processing fluid vented is fluidly isolated from the first portion of the auxiliary fluid in the first fluid flow passage.

28. The method of claim 19, further comprising constricting the primary fluid prior to mixing the primary fluid with the second portion of the auxiliary fluid.

29. The method of claim 19, further comprising constricting the mixed processing fluid prior to expelling the mixed processing fluid from the primary passage.

30. The method of claim 19, wherein the primary fluid and the auxiliary fluid are gases.

31. A nozzle for a laser processing head for processing a workpiece, the nozzle comprising:
a primary passage disposed in a body of the nozzle, the primary passage configured to direct a laser beam and a primary fluid from a proximal end of the body to a distal end of the body to process the workpiece;
a set of at least one auxiliary passage disposed in the body of the nozzle, a distal portion of the at least one auxiliary passage configured to divert into two fluid flow passages including:
a first fluid flow passage configured to direct a first portion of an auxiliary fluid in an axially forward direction toward the distal end of the nozzle body to substantially shroud the laser beam emerging from the primary passage; and
a second fluid flow passage configured to direct a second portion of the auxiliary fluid toward the primary passage to mix with the primary fluid in the primary passage; and
a set of at least one vent passage extending outward from the primary passage to fluidly connect the primary passage to atmosphere.

32. The nozzle of claim 31, wherein the second fluid flow passage is configured to direct the second auxiliary fluid portion inward toward the primary passage and in a direction axially opposite of the forward direction of the first fluid flow passage.

33. The nozzle of claim 31, wherein the second fluid flow passage is angled between about 15 degrees and about 75 degrees in relation to the first fluid flow passage.

34. The nozzle of claim 31, wherein the at least one vent passage is oriented substantially perpendicular to the primary passage.

35. The nozzle of claim 31, wherein the at least one vent passage is fluidly isolated from the first fluid flow passage.

36. A method of mixing at least two fluids within a nozzle for a laser processing head of a laser processing system, the method comprising:
directing a primary fluid axially forward through a primary passage disposed in a body of the nozzle from a proximal end to a distal end of the body;
providing an auxiliary fluid into at least one auxiliary passage disposed in the body of the nozzle;
directing at least a portion of the auxiliary fluid inward by the auxiliary passage toward the primary fluid in the primary passage; and
mixing the at least portion of the auxiliary fluid with the primary fluid in the primary passage to create a mixed processing fluid.

37. The method of claim 36, wherein a distal portion of the auxiliary passage is configured to divert into a first fluid flow passage and a second fluid flow passage.

38. The method of claim 37, further comprising directing a second portion of the auxiliary fluid axially forward through the first fluid flow passage of the auxiliary passage toward the distal end of the nozzle body.

39. The method of claim 37, wherein the at least portion of the auxiliary fluid is directed inward toward the primary fluid by the second fluid flow passage of the auxiliary passage.

40. The method of claim 36, wherein directing the at least portion of the auxiliary fluid inward comprises directing the at least portion along a direction substantially axially opposite of a direction of the primary fluid in the primary passage.

41. The method of claim 39, wherein the second fluid flow passage is angled between about 15 degrees and about 75 degrees in relation to the first fluid flow passage.

42. A nozzle for a laser processing head for processing a workpiece, the nozzle comprising:
a body;
a primary passage disposed in the body, wherein the primary passage is configured to direct a laser beam and a primary fluid from a proximal end of the body to a distal end of the body; and
at least one auxiliary passage disposed in the body, wherein the at least one auxiliary passage is configured to direct at least a portion of an auxiliary fluid toward a path of the primary fluid to mix the portion of the auxiliary fluid with the primary fluid in the body of the nozzle.
